(19) United States
(12) Patent Application Publication
(10) Pub. No.: US 2012/0196259 A1
(43) Pub. Date: Aug. 2, 2012

(54) DNA MODEL AND RELATED METHODS

(76) Inventor: Thomas Woodward, Dunedin, FL (US)

(21) Appl. No.: 13/360,069

(22) Filed: Jan. 27, 2012

Related U.S. Application Data
(60) Provisional application No. 61/437,205, filed on Jan. 28, 2011.

(51) Int. Cl. G09B 23/26

(52) U.S. Cl. 434/279

(57) ABSTRACT

A DNA model includes first and second handle members and first and second flexible connecting members each extending between the first and second handle members. The DNA model includes a plurality of pairs of first and second elongated members. The first elongated members in each of the pairs has a first end connected to the first flexible connecting member and a second end having a coupling element thereon. The second elongated members in each of the pairs has a first end connected to the second flexible connecting member and a second end having a coupling element thereon. The second ends of the first and second elongated members in the pair being are configured to couple the first elongated member in the pair to the second elongated member in the pair by the coupling element.

### RELATED APPLICATIONS

This application claims priority to U.S. Provisional Application No. 61/437,205 (Attorney Docket No. 9877-2PR), filed Jan. 28, 2011, the content of which is hereby incorporated herein by reference as if set forth its entirety.

### FIELD OF THE INVENTION

The present invention relates to DNA models, and in particular, flexible DNA models useful for illustrating DNA replication.

### BACKGROUND

Deoxyribonucleic acid, or DNA, is a nucleic acid that contains or encodes the genetic instructions used in the development and functioning of living organisms. DNA includes two long polymers whose subunits are called nucleotides having backbones made of sugars and phosphate groups joined by ester bonds. Attached to each backbone sugar is one of four types of molecules called bases. The sequence of these bases along the backbone can encode information, which is read using a genetic code that specifies the sequence of the amino acids within proteins. The information is transferred by copying stretches of DNA sequences onto another nucleic acid polymer chain, ribonucleic acid (RNA). The chemical structure of RNA is similar to that of DNA except that RNA includes the sugar ribose on its backbone, whereas DNA includes the sugar deoxyribose on its backbone. In addition, RNA has the nucleobase uracil, whereas DNA includes thymine. Also unlike DNA, most RNA molecules are single-stranded.

DNA typically exists as a pair of molecules, each having the sugar deoxyribose as a backbone and the sequence of bases. The two strands entwine in the shape of a double helix. The sugar-phosphate backbone holds the chain together, and the protruding bases interact with the bases of the other DNA strand in the helix. The four bases found in DNA are adenine (A), cytosine (C), guanine (G) and thymine (T), and each type of base on the strand forms a bond with just one other type of base on the other strand. That is, A bonds only to T and C bonds only to G. Two nucleotides binding together in this fashion on the double helix is called a base pair. In a process called DNA replication, each strand of an original double-stranded DNA helix serves as a template for the reproduction of a complementary strand. As noted above, RNA replaces the nucleobase thymine (T) of DNA with the nucleobase uracil (U). In a process called transcription, one strand of the DNA is used as a template for the production of a corresponding RNA.

DNA and/or RNA molecular models have been attempted for educational purposes. For example, U.S. Patent Publication No. 2003/0170601 to Scheetz et al. discusses a three dimensional DNA model that includes interlocking nucleotide units that are supported on a static stand. However, it may be difficult to illustrate the DNA and RNA molecular functions with static models such as those discussed in U.S. Patent Publication No. 2003/0170601 to Scheetz et al.

### SUMMARY OF EMBODIMENTS OF THE INVENTION

A DNA model includes first and second handle members and first and second flexible connecting members each extending between the first and second handle members. The DNA model includes a plurality of pairs of first and second elongated members. The first elongated member in each of the pairs has a first end connected to the first flexible connecting member and a second end having a coupling element thereon. The second elongated member in each of the pairs has a first end connected to the second flexible connecting member and a second end having a coupling element thereon. The second ends of the first and second elongated members in the pair being are configured to couple the first elongated member in the pair to the second elongated member in the pair by the coupling element.

In some embodiments, the first and second handle members are movable between a first position in which the first and second flexible connecting members extend between the first and second handle members substantially parallel to one another and define a longitudinal axis and a second position in which one of the first or second handle members are rotated about the longitudinal axis with respect to the other of the first or second handle members. The first and second flexible connecting members curve in the second position so that the first and second flexible connecting members together with the plurality of elongated members form a generally double helix shape. The first and second flexible connecting members may be sufficiently flexible so as to move between a substantially linear configuration when the handle members are in the first position and a curved configuration when the handle members are in the second position. At least one of the first and second handle members include a first handle portion and a second handle portion that are movable between a closed position in which the first and second handle portions abut one another and an open position in which the first and second handle portions are spaced apart. When the first and second handle portions are moved to the open position, the second ends of at least some of the pairs of first and second elongated members are separated and spaced apart. When the first and second handle portions are moved to the closed position, the second ends of at least some of the pairs of the first and second elongated members are coupled together. The coupling elements of the plurality of pairs of first and second elongated members comprise magnetic elements configured to couple the second ends of the first elongated members to the second ends of corresponding second elongated members.

In some embodiments, the first and second elongated members each include a DNA base portion sized and configured to represent a DNA base and a sugar portion sized and configured to represent a sugar.

In some embodiments, the model includes a plurality of spacers on the first and second flexible connecting members, and the plurality of spacers are positioned between successive ones of the plurality of first elongated members on the first flexible connecting member and between successive ones of the plurality of second elongated members on the second flexible connecting member.

In some embodiments, the first and second flexible connecting members include first and second flexible elongated strands, respectively, and the first and second elongated members each include an aperture therethrough. The first flexible connecting strand extends through the apertures of the first elongated members, and the second flexible strand extends through the apertures of the second elongated members.

In some embodiments, a DNA kit includes a DNA model comprising first and second handle members and first and second flexible connecting members each extending between the first and second handle members. The DNA model includes a plurality of pairs of first and second elongated members. The first elongated member in each of the pairs has a first end connected to the first flexible connecting member and a second end having a coupling element thereon. The second elongated member in each of the pairs has a first end connected to the second flexible connecting member and a second end having a coupling element thereon. The second ends of the first and second elongated members in the pair being are configured to couple the first elongated member in the pair to the second elongated member in the pair by the coupling element. An RNA model includes a third flexible connecting member, and a plurality of third elongated members. The third elongated members include a first end connected to the third flexible connecting member and a second end having a coupling element thereon. The second ends of the third elongated members are configured to selectively couple to the second ends of the first and/or second elongated members.

In some embodiments, a methyl tag member is configured to releasably attach to at least one of the first, second, and third elongated members.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1A is a front view of a DNA model according to some embodiments of the present invention;

FIG. 1B is a front view of the DNA model of FIG. 1 in a double helix configuration.

FIG. 2 is a cross sectional view of a portion of the DNA model of FIG. 1.

FIG. 3 is a perspective view of a portion of the DNA model of FIG. 1.

FIG. 4 is a perspective view of the portion of the DNA model in FIG. 3 with one of the DNA base elements in a disconnected position.

FIG. 5 is a front view of the DNA model of FIG. 1 with the two DNA strands in a disconnected position.

FIG. 6 is a front view of the DNA model of FIG. 1 with an RNA strand attachment according to some embodiments of the present invention.

FIG. 7 is a perspective view of the DNA model of FIG. 1 and the RNA strand attachment of FIG. 6 in a perpendicular configuration.

FIG. 8 is a perspective view of a portion of the DNA model of FIG. 1 with a methyl group attachment according to some embodiments of the present invention.

FIG. 9 is a perspective view of the methyl group attachment of FIG. 8.

### DETAILED DESCRIPTION OF EMBODIMENTS OF THE INVENTION

The present invention now will be described hereinafter with reference to the accompanying drawings and examples, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under.” The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present invention. The sequence of operations (or steps) is not limited to the order presented in the claims or figures unless specifically indicated otherwise.

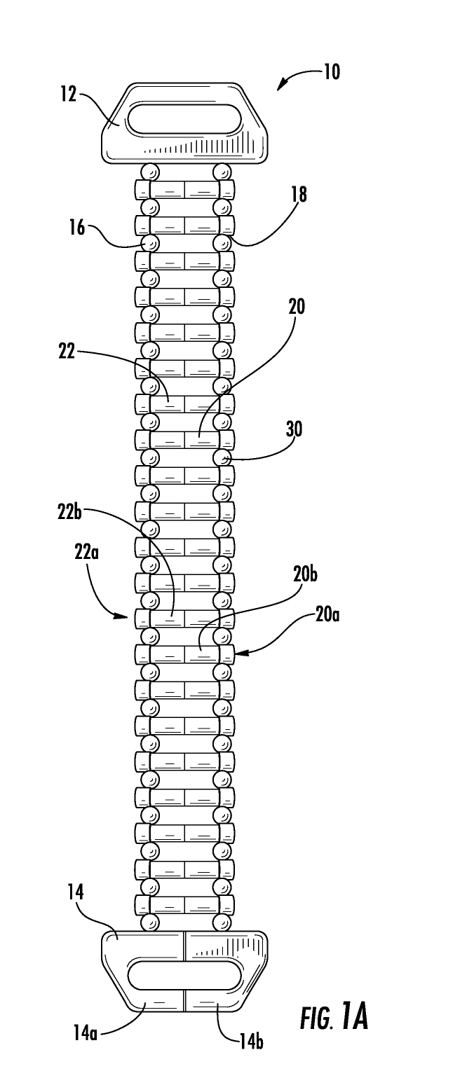

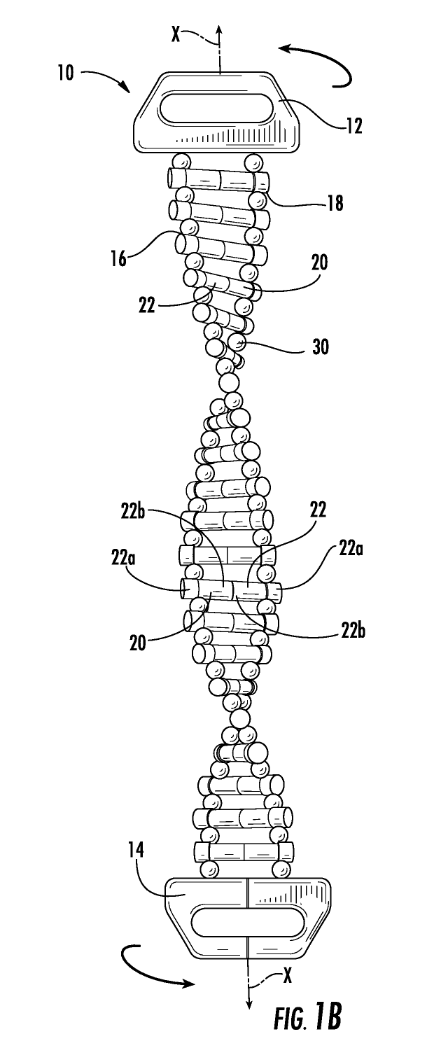

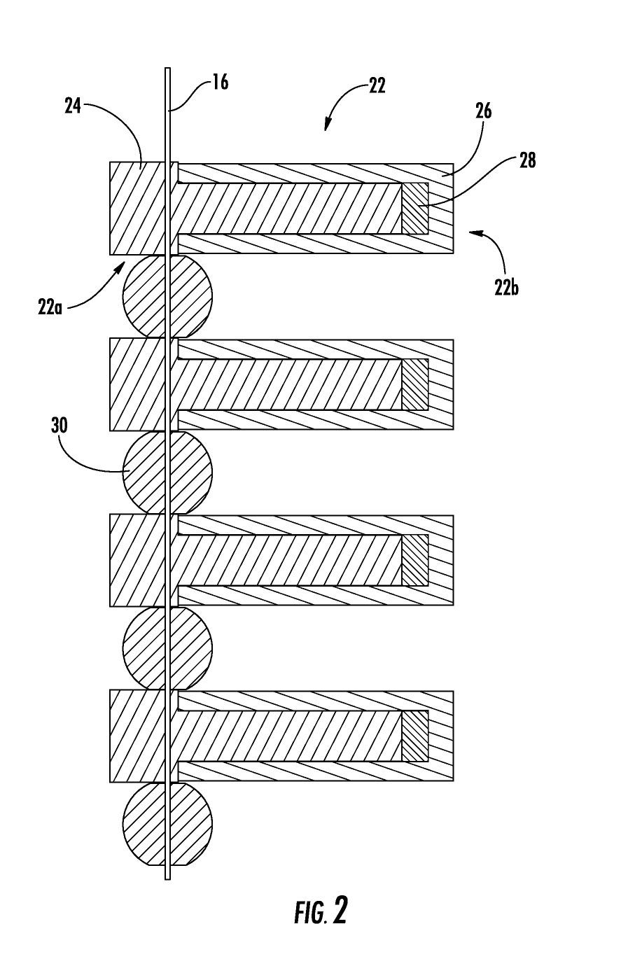

As illustrated in FIGS. 1-9, a DNA model 10 includes two handles 12, 14 having two connecting members or strands 16, 18 (FIG. 2) extending therebetween. Elongated members or DNA bases 20 include two opposing ends 20a, 20b, and are attached at one end 20a to the strand 16. Elongated members or DNA bases 22 have two opposing ends 22a, 22b, and are attached at one end 22a to the strand 18. Spacers 30 are positioned between the bases 20, 22 along the strands 16, 18. One of the handles 14 includes two handle portions 14a, 14b. As illustrated, the ends 20a, 22a of the bases 20, 22 represent sugars, the spacers 30 represent phosphates, and the ends 22a, 22b of the bases 20, 22 represent specific DNA bases, e.g., adenine (A), cytosine (C), guanine (G) and thymine (T). For example, the ends 22a, 22b may be colored and/or shaped to visually indicate one of the DNA bases (A, C, G or T) to a user of the model 10.

As shown in FIG. 1B, the connecting strands 16, 18 between the handles 12, 14 define a longitudinal axis X such that rotation of one of the handles 12, 14 with respect to the other of the handles 12, 14 causes the connecting strands 16, 18 to rotate, thus forming a double helix shape that is characteristic of DNA molecules. Thus, the model 10 is movable between a generally straight or linear configuration as shown in FIG. 1A and the twisted, double helix shape shown in FIG. 1B.

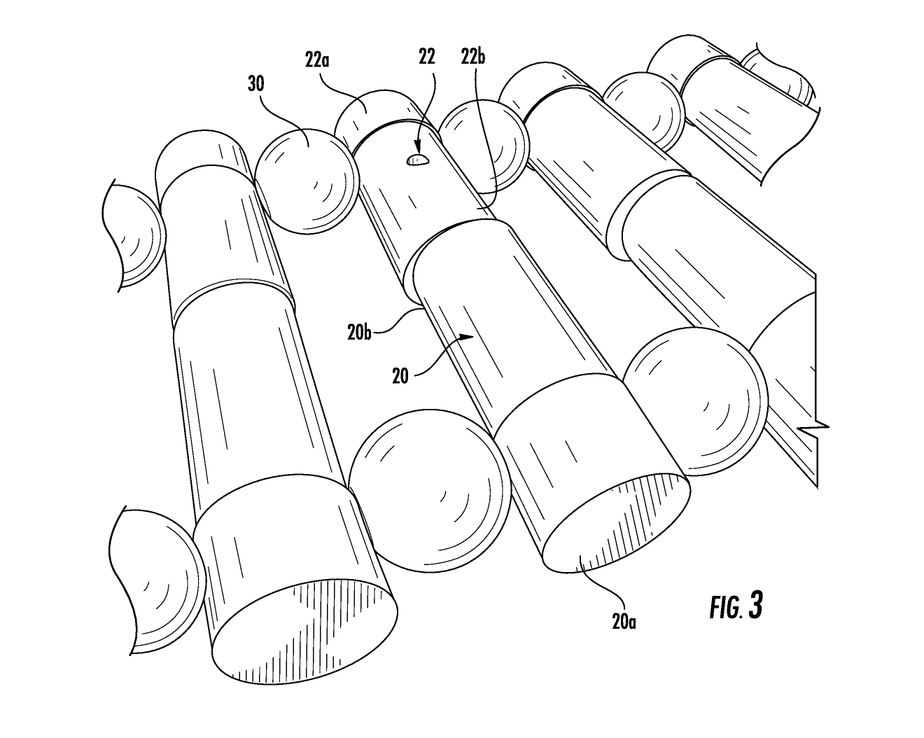

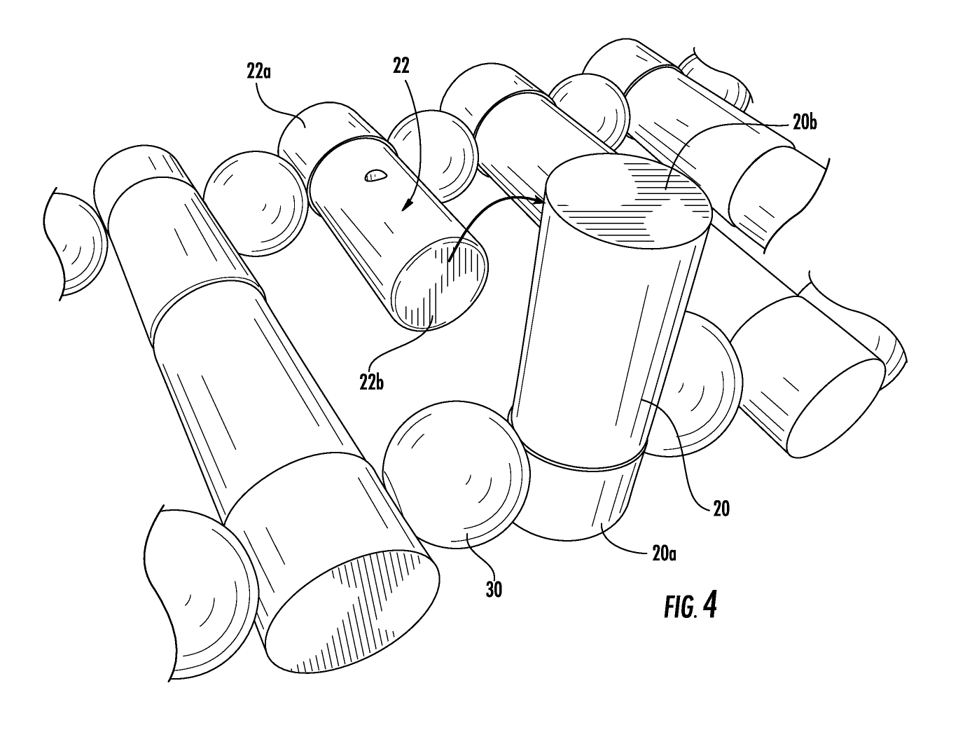

As illustrated in FIG. 2, each of the DNA bases 22 has an inner portion 24, an outer sheath 26 and a magnetic coupling element 26. It should be understood that the DNA bases 20 have a configuration analogous to that shown in FIG. 2 with respect to the DNA bases 22. In this configuration, the magnetic element 26 in the end 22b of the DNA base 22 is configured to magnetically couple to a corresponding magnetic element in the end 20b of an opposing DNA base 20 in the pair of bases 20, 22. Accordingly, the DNA bases 20, 22 may releasably couple and decouple as illustrated for example, in FIGS. 3-4.

In some embodiments, the ends 20a, 22a may be configured and/or colored to represent a sugar deoxyribose as a backbone. For example, white or another color may be used to represent the sugar deoxyribose. Any suitable combination of color and/or shapes may be used to represent the deoxyribose backbone. In some embodiments, the opposite free ends 22a, 22b may be configured and/or colored so as to represent different DNA bases. For example, different colors and/or shapes may be used to represent adenine (A), cytosine (C), guanine (G) and thymine (T), and the colors/shapes of bases 20, 22 may be arranged so that the bases 20, 22 with a color/shape corresponding to A couple only to the bases 20, 22 with a color/shape corresponding to T, and bases 20, 22 with the color/shape corresponding to C bonds only to bases 20, 22 with a color/shape corresponding to G. Moreover, although the ends 20a, 20b and the ends 22a, 22b are illustrated as being generally cylindrical in shape, it should be understood that any suitable shape and/or color may be used to generally indicated that the bases 20, 22 represent base pairs of two nucleotides binding or coupling together on the double helix.

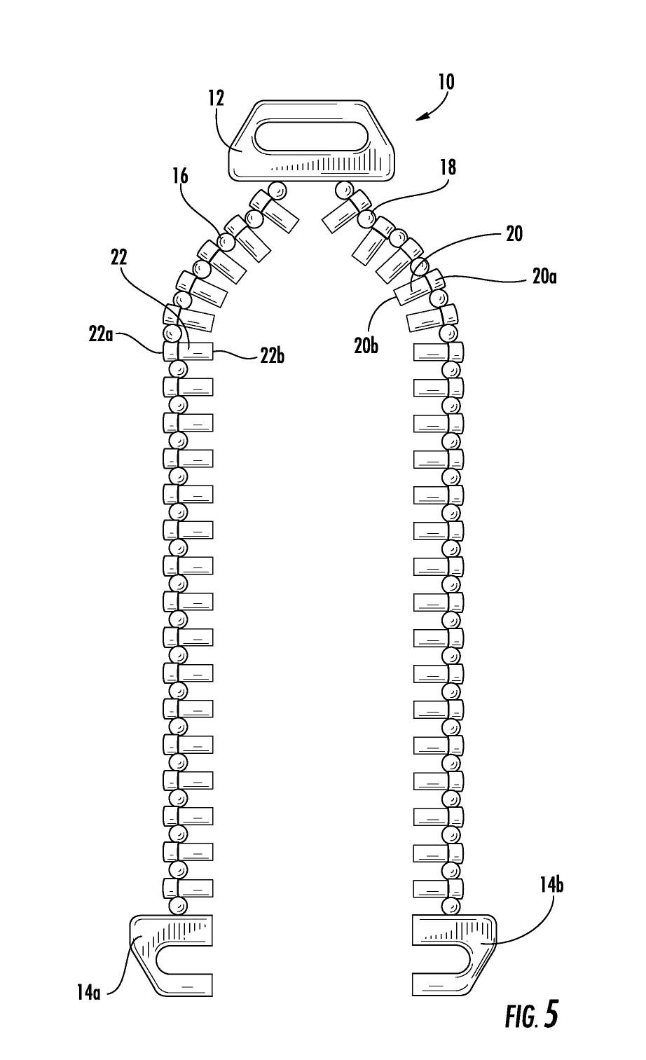

As shown in FIG. 5, the DNA strands 16, 18 may be separated or “unzipped” into an open configuration by moving the handle portions 14a, 14b from the closed position shown in FIG. 1A to the open configuration shown in FIG. 5. In the configuration illustrated in FIG. 5, the handle 12 holds the strands 16, 18 together; however, the separated handle portions 14a, 14b of the handle 14 permit flexible separation of the DNA strands 16, 18 and magnetic decoupling of the DNA bases 22. In some embodiments, the strands 16, 18 may be sufficiently flexible so as to permit movement between the linear configuration shown in FIG. 1A, the double helix configuration shown in FIG. 1B, and the open or decoupled configuration shown in FIG. 5.

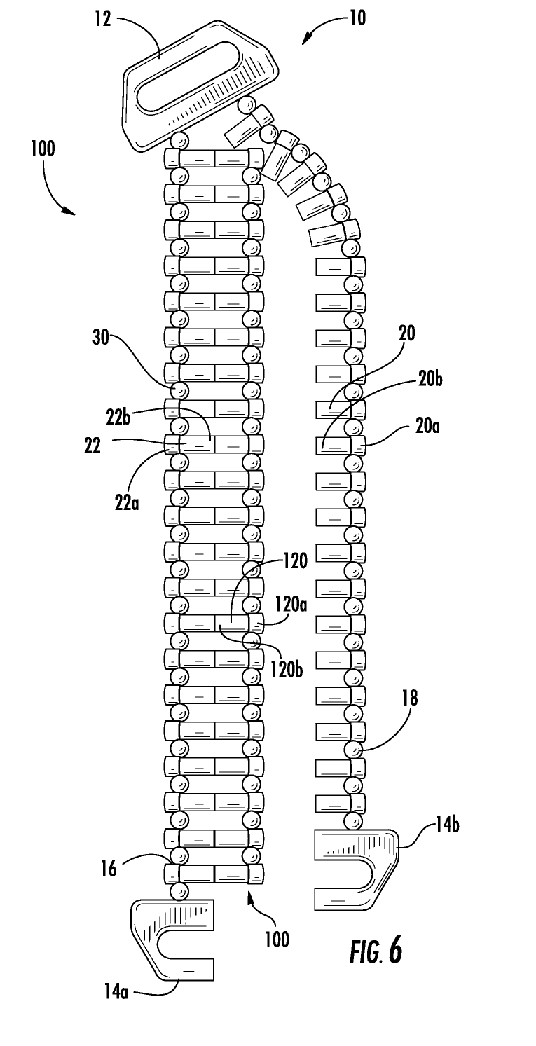

As shown in FIG. 6, an RNA model 100 includes a strand 116, elongated members or RNA bases 120, each having two ends 120a, 120b, and spacers 130. The RNA bases 120 may be structurally configured in a manner analogous to that shown with respect to the DNA bases 22 of FIG. 2. Stated otherwise, the end 120b of the RNA bases 120 may include a magnetic element such that the RNA bases 120 may be attached or magnetically coupled to the ends 22b of the DNA bases 22 as shown in FIG. 6. In addition, the RNA bases 120 may be colored and/or shaped to represent adenine (A), cytosine (C), guanine (G) and uracil (U). Accordingly, DNA transcription processes may be illustrated and the interaction between DNA and RNA may be shown. Similarly, DNA replication processes may be illustrated with another DNA strand. As shown, the RNA strand 100 is substantially the same length as the corresponding DNA strand 16; however, it should be understood that the RNA strand 100 may be shorter than the DNA strand 16. Thus, the DNA strand 16 may be connected to only a portion of the DNA strand 16 or may extend along the entire DNA strand 16 as illustrated in FIG. 6. Moreover, although the DNA strand 16 is illustrated as being connected to the bases 22 of the strand 16, it should be understood that DNA strands may be used to connect to the bases 20 of the strand 18. Therefore, RNA strands may be provided that magnetically couple to either one or both of the DNA strands 16, 18.

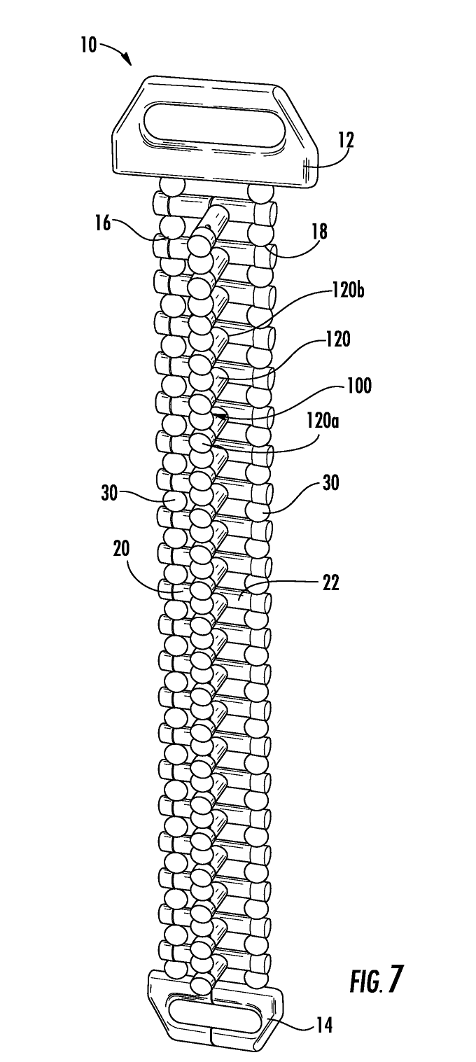

As shown in FIG. 7, in some embodiments, the bases 120 of the RNA model 100 may be magnetically coupled to one or both of the bases 20, 22 of the DNA strands 16, 18 when the bases 20, 22 are simultaneously coupled to one another by the ends 20b, 22b. Thus, various configurations and interactions between the RNA model 100 and the DNA model 10 may be facilitated, e.g., for educational and/or demonstration purposes.

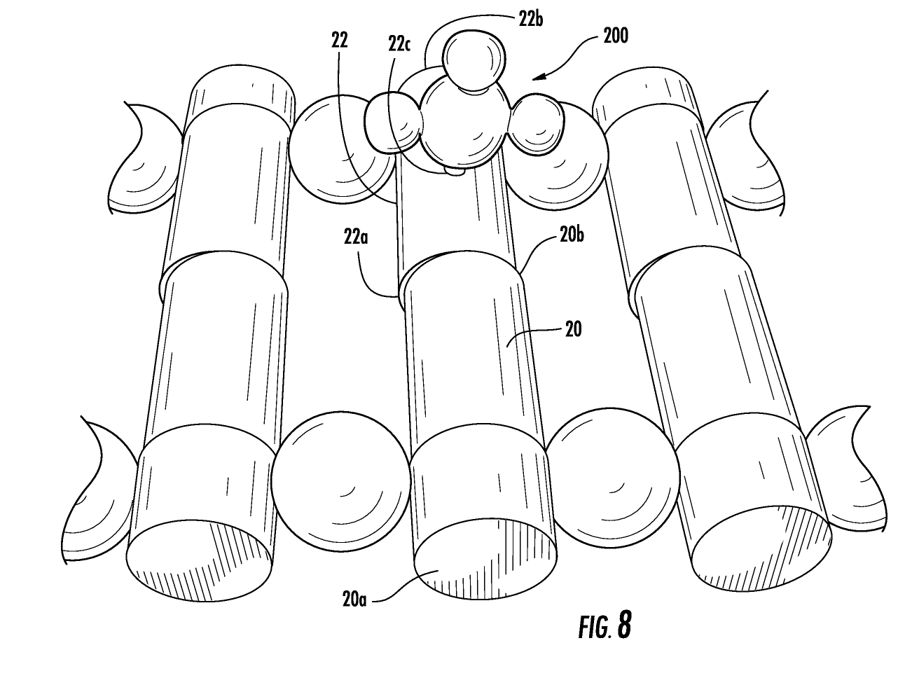

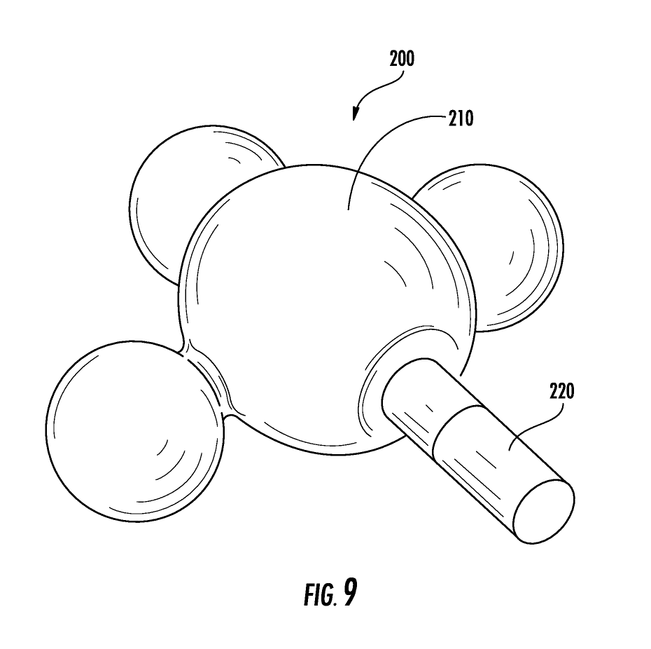

In some embodiments, additional components of DNA and/or RNA or other chemical materials may be affixed to the models 10, 100. For example, it is generally understood by geneticists that methyl groups may bind to DNA bases and “turn off” the genetic information of the bound base and its surrounding DNA sequence. As illustrated in FIGS. 8-9, an element 200 representing a methyl group may be releasably attached to one of the DNA bases 20. As shown in FIG. 9, the methyl group element 200 may include a body portion 210 and a peg 220. As shown in FIG. 8, one or more of the DNA bases 20 may include an aperture 22c for receiving the peg 220. Although as illustrated in FIG. 8, the methyl group element peg 220 is press-fit into the aperture 22c, it should be understood that any suitable connecting configuration may be used, such as other interlocking shapes, magnetic components, hook and look or burr attachments (e.g., Velcro® attachments), and the like.

Although embodiments according to the present invention are illustrated herein with respect to linear, rod-shaped bases 20, 22, it should be understood that any suitable shape may be used, including elongated shapes having any suitable cross sectional shape. Moreover, the bases 20, 22 may be symmetrical or other asymmetrical shapes may be used. The bases 20, 22 may be all of similar shapes, or different shapes may be used, for example, to indicate adenine (A), cytosine (C), guanine (G) and thymine (T) (or uracil (U) in the case of RNA).

Magnetic elements 26 may be used to magnetically couple the DNA bases 20, 22 together in pairs as illustrated, for example, in FIG. 2. However, any suitable coupling element may be used to releasably couple the bases 20, 22 together in pairs, such as hook and loop fasteners or burr fasteners (e.g., Velcro® fasteners), interlocking shapes, snap fit designs, press fit designs, etc.

The strands 16, 18 may be formed of flexible string or wire, for example to permit ease of movement and/or curvature of the strands 16, 18 into a double helix shape (FIG. 1B) or other shapes that may be desired by a user for illustrative purposes. The bases 20, 22 may be formed of any suitable material, such as elastomeric materials, wood, metal, etc. The bases 20, 22 and the spacers 30 may be attached to the strands 16, 18 by threading the strands 16, 18 through apertures in the bases 20, 22 and spacers 30 as illustrated; however, the bases 20, 22 and spacers 30 may be affixed to the strands 16, 18 or other connecting members by adhesive, interlocking shapes, snap or press fit connectors, etc. In some embodiments, the strands 16, 18 may be omitted and the bases 20, 22 and spacers 30 may be connected directly to one another via connecting members that are separate from or formed integral with the connected bases 20, 22 and spacers 30. Such connecting members may permit rotational movement, flexible rotation and/or curvature into a linear and double helix shape as described herein.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A DNA model comprising:
first and second handle members;
first and second flexible connecting members each extending between the first and second handle members;
a plurality of pairs of first and second elongated members, wherein the first elongated member in each of the pairs has a first end connected to the first flexible connecting member and a second end having a coupling element thereon, and the second elongated member in each of the pairs has a first end connected to the second flexible connecting member and a second end having a coupling element thereon, the second ends of the first and second elongated members in the pair being configured to couple the first elongated member in the pair to the second elongated member in the pair by the coupling element.

2. The DNA model of claim 1, wherein first and second handle members are movable between a first position in which the first and second flexible connecting members extend between the first and second handle members substantially parallel to one another and define a longitudinal axis and a second position in which one of the first or second handle members are rotated about the longitudinal axis with respect to the other of the first or second handle members, and the first and second flexible connecting members curve in the second position so that the first and second flexible connecting members together with the plurality of elongated members form a generally double helix shape.

3. The DNA model of claim 2, wherein the first and second flexible connecting members are sufficiently flexible so as to move between a substantially linear configuration when the handle members are in the first position and a curved configuration when the handle members are in the second position.

4. The DNA model of claim 2, wherein at least one of the first and second handle members comprises a first handle portion and a second handle portion that are movable between a closed position in which the first and second handle portions abut one another and an open position in which the first and second handle portions are spaced apart.

5. The DNA model of claim 4, wherein when the first and second handle portions are moved to the open position, the second ends of at least some of the pairs of first and second elongated members are separated and spaced apart.

6. The DNA model of claim 4, wherein when the first and second handle portions are moved to the closed position, the second ends of at least some of the pairs of the first and second elongated members are coupled together.

7. The DNA model of claim 4, wherein the coupling elements of the plurality of pairs of first and second elongated members comprise magnetic elements configured to couple the second ends of the first elongated members to the second ends of corresponding second elongated members.

8. The DNA model of claim 1, wherein the first and second elongated members each comprise a DNA base portion sized and configured to represent a DNA base and a sugar portion sized and configured to represent a sugar.

9. The DNA model of claim 1, further comprising a plurality of spacers on the first and second flexible connecting members, wherein the plurality of spacers are positioned between successive ones of the plurality of first elongated members on the first flexible connecting member and between successive ones of the plurality of second elongated members on the second flexible connecting member.

10. The DNA model of claim 1, wherein the first and second flexible connecting members comprise first and second flexible elongated strands, respectively, and the first and second elongated members each include an aperture therethrough, wherein the first flexible connecting strand extends through the apertures of the first elongated members, and the second flexible strand extends through the apertures of the second elongated members.

11. A DNA kit comprising:
a DNA model comprising:
first and second handle members;
first and second flexible connecting members each extending between the first and second handle members;
a plurality of pairs of first and second elongated members, wherein the first elongated members in each of the pairs has a first end connected to the first flexible connecting member and a second end having a coupling element thereon, and the second elongated members in each of the pairs has a first end connected to the second flexible connecting member and a second end having a coupling element thereon, the second ends of the first and second elongated members in the pair being configured to selectively couple the first elongated member in the pair to the second elongated member in the pair by the coupling element; and
an RNA model comprising:
a third flexible connecting member; and
a plurality of third elongated members, wherein the third elongated members comprise a first end connected to the third flexible connecting member and a second end having a coupling element thereon;
wherein the second ends of the third elongated members are configured to selectively couple to the second ends of the first and/or second elongated members.

12. The DNA kit of claim 11, further comprising a methyl tag member configured to releasably attach to at least one of the first, second, and third elongated members.

13. The DNA kit of claim 11, wherein first and second handle members are movable between a first position in which the first and second flexible connecting members extend between the first and second handle members substantially parallel to one another and define a longitudinal axis and a second position in which one of the first or second handle members are rotated about the longitudinal axis with respect to the other of the first or second handle members, and the first and second flexible connecting members curve in the second position so that the first and second flexible connecting members together with the plurality of elongated members form a generally double helix shape.

14. The DNA kit of claim 13, wherein the first and second flexible connecting members are sufficiently flexible so as to move between a substantially linear configuration when the handle members are in the first position and a curved configuration when the handle members are in the second position.

15. The DNA kit of claim 13, wherein at least one of the first and second handle members comprises a first handle portion and a second handle portion that are movable between a closed position in which the first and second handle portions abut one another and an open position in which the first and second handle portions are spaced apart.

16. The DNA kit of claim 15, wherein when the first and second handle portions are moved to the open position, the second ends of at least some of the pairs of first and second elongated members are separated and spaced apart.

17. The DNA kit of claim 15, wherein when the first and second handle portions are moved to the closed position, the second ends of at least some of the pairs of the first and second elongated members are coupled together.

18. The DNA kit of claim 15, wherein the coupling elements of the plurality of pairs of first and second elongated members comprise magnetic elements configured to couple the second ends of the first elongated members to the second ends of corresponding second elongated members.

19. The DNA kit of claim 11, wherein the first and second elongated members each comprise a DNA base portion sized and configured to represent a DNA base and a sugar portion sized and configured to represent a sugar.

20. The DNA kit of claim 11, further comprising a plurality of spacers on the first and second flexible connecting members, wherein the plurality of spacers are positioned between successive ones of the plurality of first elongated members on the first flexible connecting member and between successive ones of the plurality of second elongated members on the second flexible connecting member.

21. The DNA kit of claim 11, wherein the first and second flexible connecting members comprise first and second flexible elongated strands, respectively, and the first and second elongated members each include an aperture therethrough, wherein the first flexible connecting strand extends through the apertures of the first elongated members, and the second flexible strand extends through the apertures of the second elongated members.

22. A method of demonstrating DNA operations, the method comprising:
providing a DNA kit comprising:
a DNA model comprising:
first and second handle members;
first and second flexible connecting members each extending between the first and second handle members;
a plurality of pairs of first and second elongated members, wherein the first elongated members in each of the pairs has a first end connected to the first flexible connecting member and a second end having a coupling element thereon, and the second elongated members in each of the pairs has a first end connected to the second flexible connecting member and a second end having a coupling element thereon, the second ends of the first and second elongated members in the pair being configured to selectively couple the first elongated member in the pair to the second elongated member in the pair by the coupling element; and
an RNA model comprising:
a third flexible connecting member; and
a plurality of third elongated members, wherein the third elongated members comprise a first end connected to the third flexible connecting member and a second end having a coupling element thereon; and
selectively coupling the second ends of the first elongated members to the second ends of the second and/or third elongated members.
